(19) United States
(12) Patent Application Publication
(10) Pub. No.: US 2011/0167018 A1
(43) Pub. Date: Jul. 7, 2011

(54) Prioritizing and Tracking Investments

(76) Inventors: VICKI HAMILTON, ROSWELL, GA (US); MELISSA KOEHLER, ACWORTH, GA (US); MICHELLE MCGUIRE, MARIETTA, GA (US); KAREN PAINTER, GRANTVILLE, GA (US); KATHRYN AUFDERHEIDE, MABLETON, GA (US); JONJIE THRALLS, ATLANTA, GA (US); ALAY MEHTA, LAWRENCEVILLE, GA (US); MARK CHERNESKY, STONE MOUNTAIN, GA (US); SIMIT SHAH, ATLANTA, GA (US); CATHERINE EVANS, ACWORTH, GA (US); MARK HARTMAN, ATLANTA, GA (US); JENNIFER DAVIDSON, ATLANTA, GA (US); JOHN R. DAVIDSON, ATLANTA, GA (US); MANISH KHANDURI, ATLANTA, GA (US); FARAH SPAINHOUR, ATLANTA, GA (US); CATHERINE HAGUE, POWDER SPRINGS, GA (US); SCOTT MURPHY, ATLANTA, GA (US)

(21) Appl. No.: 12/651,759

(22) Filed: Jan. 4, 2010

(51) Int. Cl. G06Q 40/00

(52) U.S. Cl. 705/36 R

(57) ABSTRACT

Systems, methods, and computer program products are provided for assisting in understanding and tracking the potential risks and rewards of investment projects so that they can be efficiently evaluated for approval and tracked for progress. For example, in one embodiment, an investment system causes display of input requests and receives responses to the input requests from conception of the investment project to completion of the investment project.

### BACKGROUND

The strategic investment of an entity's resources may have a substantial impact on the success of the entity. For example, in making investment decisions, a business needs to (a) understand the goals, risks, and rewards of its potential investment projects, such as campaign launches, information technology (“IT”) projects, marketing launches, product development, and/or the like; (b) be able to efficiently evaluate the plans of a variety of investment projects; and (c) track the progress of investment projects from conceptualization to completion. Thus, there is a need for a solution to prioritize and track investment projects.

### BRIEF SUMMARY

In general, embodiments of the present invention provide systems, methods, apparatus, and computer program products for prioritizing and tracking one or more investment projects.

In accordance with one aspect, a computer-implemented method is provided. In one embodiment, the computer-implemented method comprises (a) receiving input identifying an investment project; (b) assigning a unique identifier to the investment project; (c) receiving input identifying an estimated cost for the investment project; (d) receiving input identifying an expected benefit of the investment project; and (e) causing display of a first input request that is related to the design of the investment project and that is associated with the expected benefit. In this embodiment, the computer-implemented method also comprises (f) receiving a response to the first input request; (g) causing display of a second input request that is related to the development of the investment project; (h) receiving a response to the second input request; (i) receiving input indicating that the investment project has been completed; and (j) in response to receiving input indicating that the investment project has been completed, causing display of a third input request that is related to feedback of the investment project.

In accordance with another aspect, another computer-implemented method is provided. In one embodiment, the computer-implemented method comprises (a) receiving, via one or more processors, input identifying an investment project; (b) receiving, via the one or more processors, input identifying an expected benefit of the investment project; (c) receiving, via the one or more processors, input requesting submission of the investment project for initial approval; (d) in response to receiving input requesting submission of the investment project for initial approval, electronically (1) submitting the investment project for initial approval and (2) providing notification to a user computing device that the investment project has been submitted for initial approval; and (e) causing display of a first input request that is related to the design of the investment project and that is associated with the expected benefit.

In accordance with yet another aspect, a computer program product is provided. The computer program product may comprise at least one computer-readable storage medium having computer-readable program code portions stored therein, the computer-readable program code portions comprising executable portions configured to (a) receive input identifying an investment project; (b) receive input identifying an expected benefit of the investment project; and (c) receive input requesting submission of the investment project for initial approval. The computer-readable program code portions may also comprise executable portions configured to (d) in response to receiving input requesting submission of the investment project for initial approval, (1) submit the investment project for initial approval and (2) provide notification to a user computing device that the investment project has been submitted for initial approval; and (e) cause display of a first input request that is related to the design of the investment project and that is associated with the expected benefit.

And in yet another aspect, a system for prioritizing and tracking one or more investment projects is provided. In one embodiment, the system is configured to (a) receive input identifying an investment project; (b) receive input identifying an expected benefit of the investment project; (c) receive input requesting submission of the investment project for initial approval; (d) in response to receiving input requesting submission of the investment project for initial approval, (1) submit the investment project for initial approval and (2) provide notification to a user computing device that the investment project has been submitted for initial approval; (e) cause display of a first input request that is related to the design of the investment project and that is associated with the expected benefit; and (f) receive a response to the first input request.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an overview of a management system according to various embodiments of the present invention.

FIG. 2 is an exemplary schematic diagram of an investment system according to one embodiment of the present invention.

FIGS. 3-4 are flowcharts illustrating operations and processes that can be used in accordance with various embodiments of the present invention.

FIGS. 5-38 are universal input and output produced by one embodiment of the invention.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. Like numbers refer to like elements throughout.

### I. METHODS, APPARATUS, SYSTEMS, AND COMPUTER PROGRAM PRODUCTS

As should be appreciated, various embodiments may be implemented in various ways, including as methods, apparatus, systems, or computer program products. Accordingly, various embodiments may take the form of an entirely hardware embodiment or an embodiment in which a processor is programmed to perform certain steps. Furthermore, various implementations may take the form of a computer program product on a computer-readable storage medium having computer-readable program instructions embodied in the storage medium. Any suitable computer-readable storage medium may be utilized including hard disks, CD-ROMs, optical storage devices, or magnetic storage devices.

Various embodiments are described below with reference to block diagrams and flowchart illustrations of methods, apparatus, systems, and computer program products. It should be understood that each block of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

### II. GENERAL OVERVIEW

In general, according to various embodiments of the present invention, methods, apparatus, systems, and computer program products are provided for enabling entities to: (a) understand the goals, risks, and rewards of potential investment projects; (b) efficiently evaluate the plans of a variety of investment projects; and (c) track the progress of investment projects from conceptualization to completion. For example, an investment system according to a particular embodiment of the invention receives input about a particular investment project and submits the investment project for approval. In response to the investment project being approved, the investment system: (a) causes display of (and receives responses to) requests for information about the design of the investment project; and (b) submits the design of the investment project for approval. In response to the design of the investment project being approved, the investment system: (a) causes display of (and receives responses to) requests for information about the actual development of the investment project as the development occurs; and (b) requests an approval to continue development of the investment project. After the investment project is complete, the investment system causes display of (and receives responses to) requests for information about the completion of the investment project as a way of receiving feedback concerning the investment project.

### III. EXEMPLARY SYSTEM ARCHITECTURE

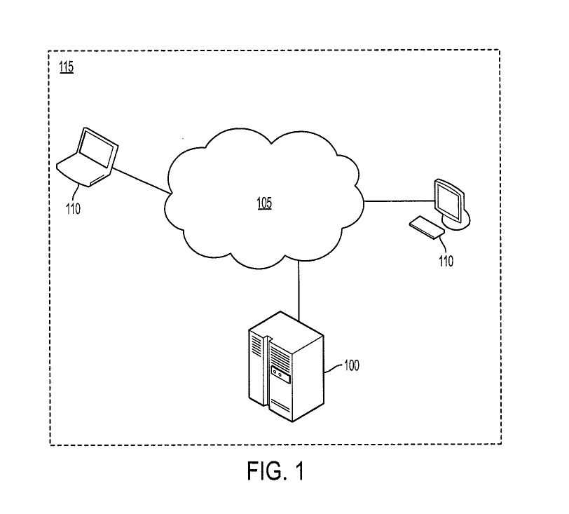

FIG. 1 provides an illustration of a management system 115 that can be used in conjunction with various embodiments of the present invention. As shown in FIG. 1, the management system 115 may include an investment system 100, a network 105, and one or more user computing devices 110. Each of these components of the management system 115 may be in electronic communication with, for example, one another over the same or different wireless or wired networks including, for example, a wired or wireless Personal Area Network (“PAN”), Local Area Network (“LAN”), Metropolitan Area Network (“MAN”), Wide Area Network (“WAN”), or the like. Additionally, while FIG. 1 illustrates the various system entities as separate, standalone entities, the various embodiments are not limited to this particular architecture.

a. Investment System

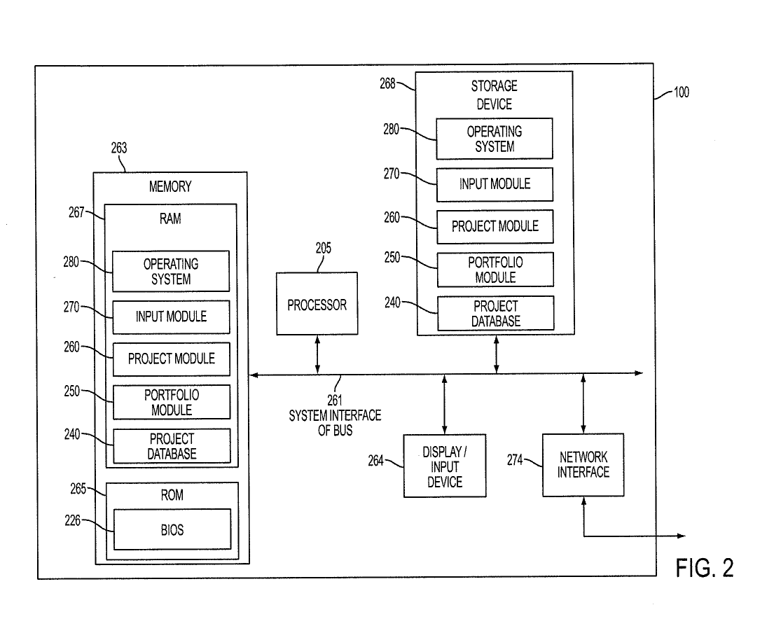

FIG. 2 provides a schematic of an investment system 100 according to one embodiment of the present invention. In general, the term “system” may refer to, for example, any computer, computing device, desktop, notebook or laptop, distributed system, server, gateway, switch, or other processing device adapted to perform the functions described herein. As will be understood from this figure, in this embodiment, the investment system 100 includes a processor 205 that communicates with other elements within the investment system 100 via a system interface or bus 261. The processor 205 may be embodied in a number of different ways. For example, the processor 205 may be embodied as various processing means such as a processing element, a coprocessor, a controller or various other processing devices including integrated circuits such as, for example, an application specific integrated circuit (“ASIC”), a field programmable gate array (“FPGA”), a hardware accelerator, or the like.

In an exemplary embodiment, the processor 205 may be configured to execute instructions stored in the device memory or otherwise accessible to the processor 205. As such, whether configured by hardware or software methods, or by a combination thereof, the processor 205 may represent an entity capable of performing operations according to embodiments of the present invention while configured accordingly. A display device/input device 264 for receiving and displaying data is also included in the investment system 100. This display device/input device 264 may be, for example, a keyboard or pointing device that is used in combination with a monitor. The investment system 100 further includes memory 263, which may include both read only memory (“ROM”) 265 and random access memory (“RAM”) 267. The investment system's ROM 265 may be used to store a basic input/output system (“BIOS”) 226 containing the basic routines that help to transfer information to the different elements within the investment system 100.

In addition, in one embodiment, the investment system 100 includes at least one storage device 268, such as a hard disk drive, a CD drive, and/or an optical disk drive for storing information on various computer-readable media. The storage device(s) 268 and its associated computer-readable media may provide nonvolatile storage. The computer-readable media described above could be replaced by any other type of computer-readable media, such as embedded or removable multimedia memory cards (“MMCs”), secure digital (“SD”) memory cards, Memory Sticks, electrically erasable programmable read-only memory (“EEPROM”), flash memory, hard disk, or the like. Additionally, each of these storage devices 268 may be connected to the system bus 261 by an appropriate interface.

Furthermore, a number of program modules may be stored by the various storage devices 268 and/or within RAM 267. Such program modules may include an operating system 280, an input module 270, a project module 260, and a portfolio module 250. These modules may control certain aspects of the operation of the investment system 100 with the assistance of the processor 205 and operating system 280—although their functionality need not be modularized. In addition to the program modules, the investment system 100 may store or be connected to one or more databases, such as a project database 240, with one or more tables stored therein.

Also located within the investment system 100, in one embodiment, is a network interface 274 for interfacing with various computing entities. This communication may be via the same or different wired or wireless networks (or a combination of wired and wireless networks), as discussed above. For instance, the communication may be executed using a wired data transmission protocol, such as fiber distributed data interface (“FDDI”), digital subscriber line (“DSL”), Ethernet, asynchronous transfer mode (“ATM”), frame relay, data over cable service interface specification (“DOCSIS”), or any other wired transmission protocol. Similarly, the investment system 100 may be configured to communicate via wireless external communication networks using any of a variety of protocols, such as 802.11, general packet radio service (“GPRS”), wideband code division multiple access (“W-CDMA”), or any other wireless protocol.

It will be appreciated that one or more of the investment system's 100 components may be located remotely from other investment system 100 components. Furthermore, one or more of the components may be combined and additional components performing functions described herein may be included in the investment system 100.

b. Additional Exemplary System Components

The user computing devices 110 may each include one or more components that are functionality similar to those of the investment system 100. For example, in one embodiment, each of the user computing devices may include: (1) a processor that communicates with other elements via a system interface or bus; (2) a display device/input device; (3) memory including both ROM and RAM; (4) a storage device; and (5) a network interface. These architectures are provided for exemplary purposes only and are not limiting to the various embodiments. The term “computing device” is used generically to refer to any computer, computing device, desktop, notebook or laptop, distributed system, server, gateway, switch, or other processing device adapted to perform the functions described herein.

### IV. EXEMPLARY SYSTEM OPERATION

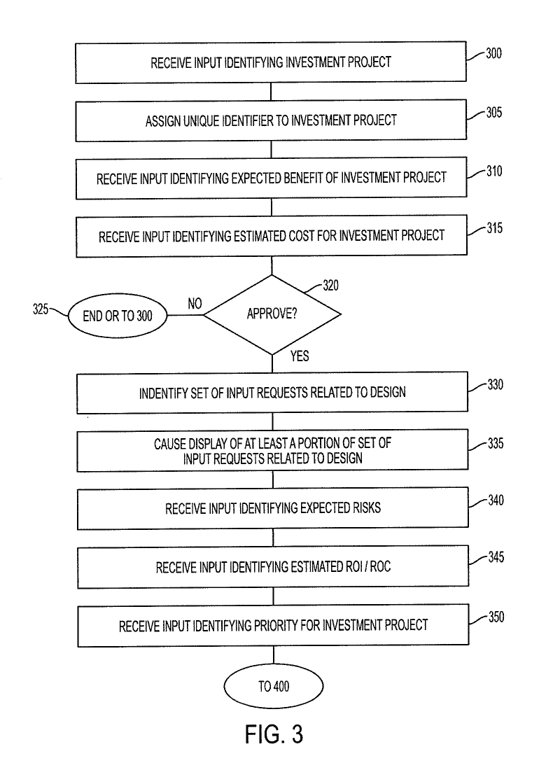

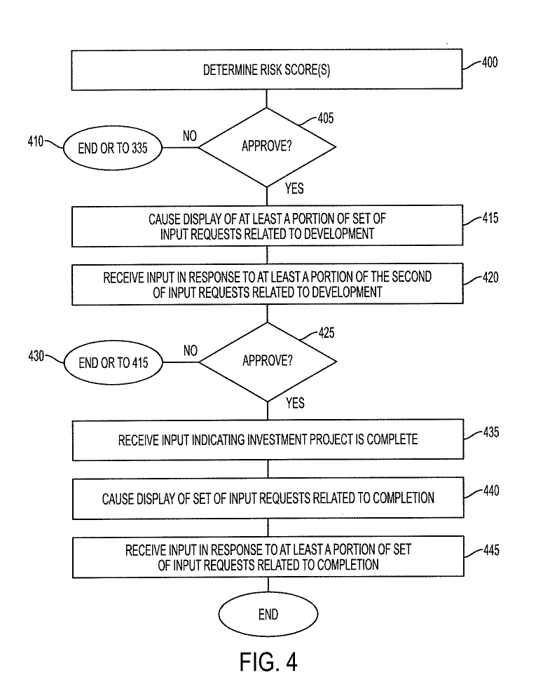

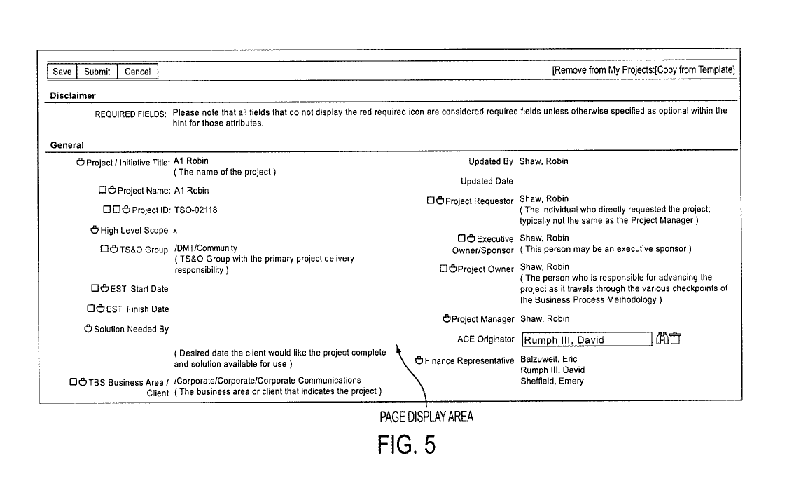

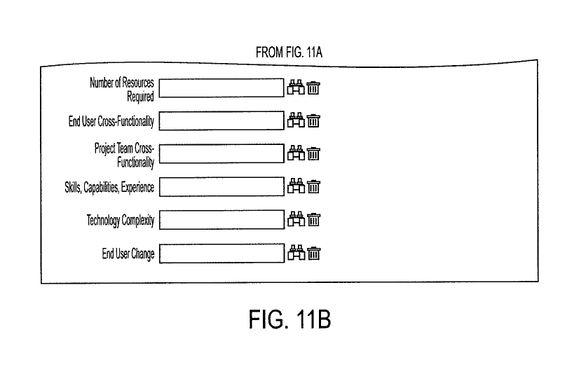

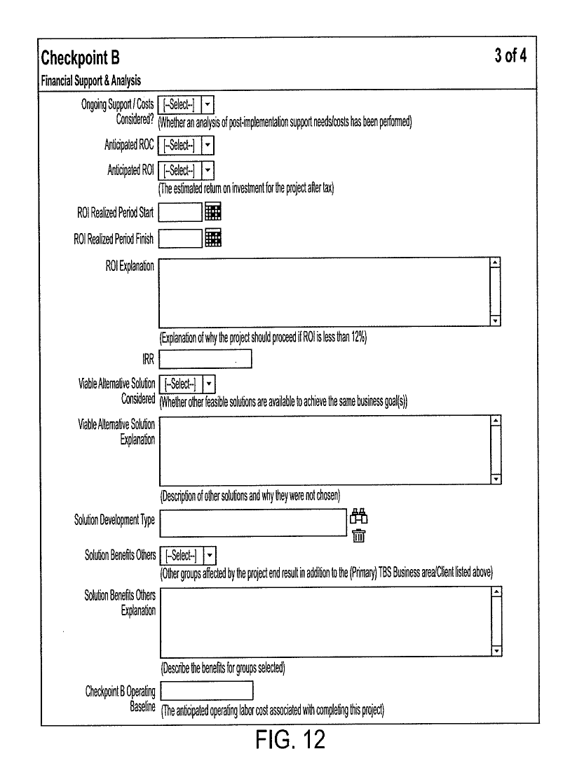

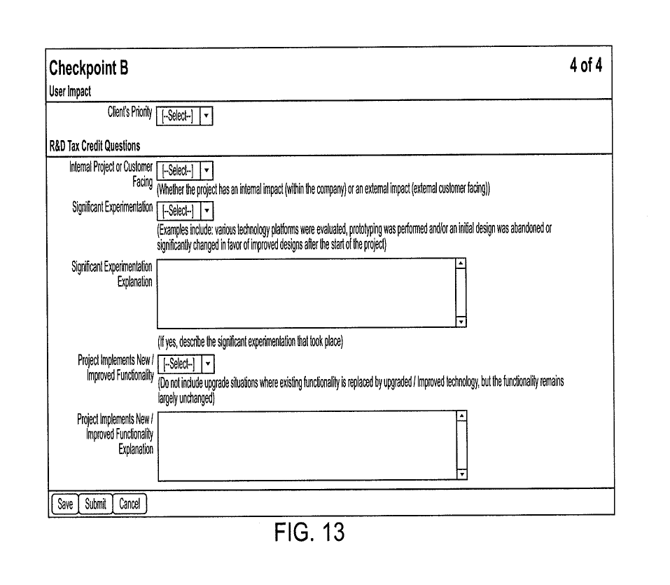

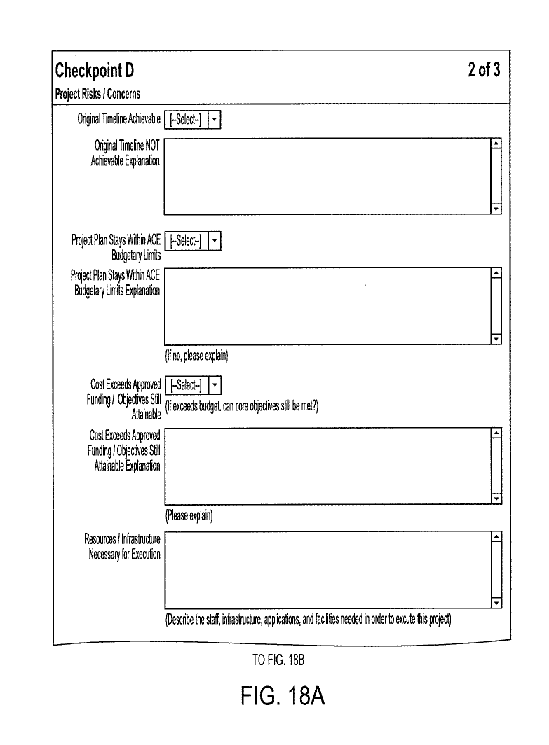

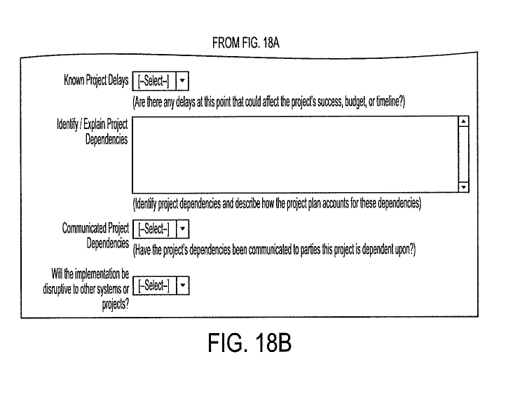

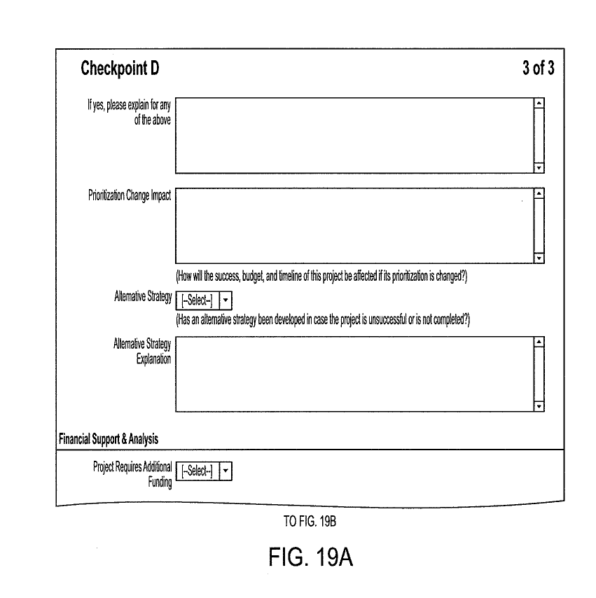

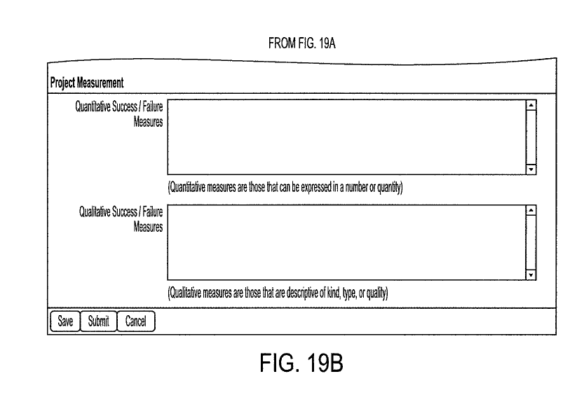

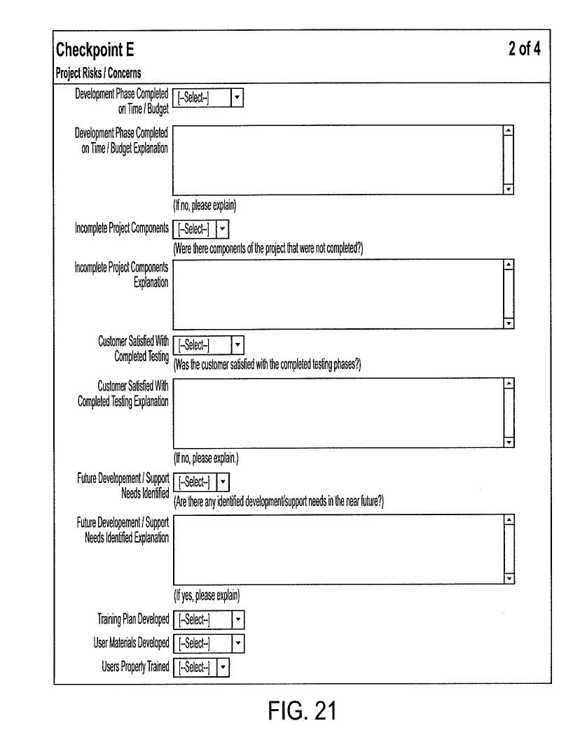

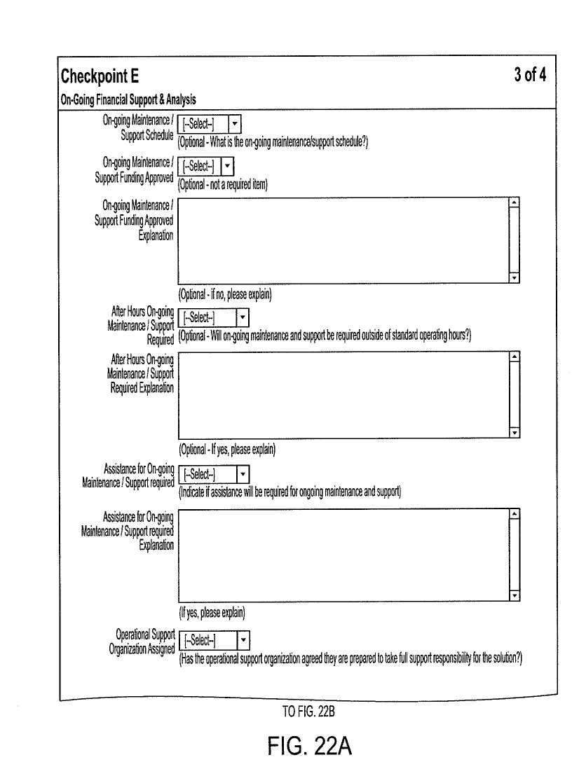

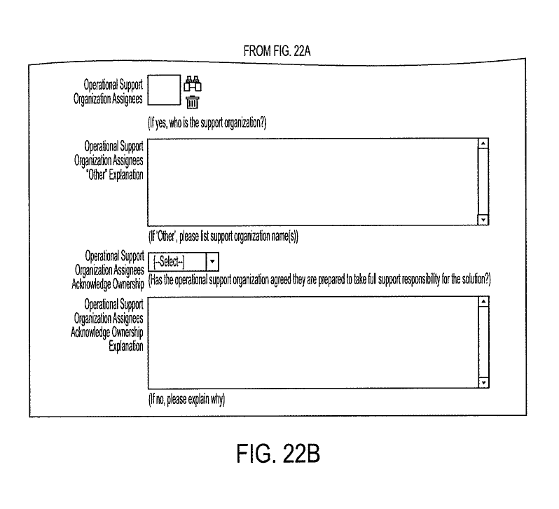

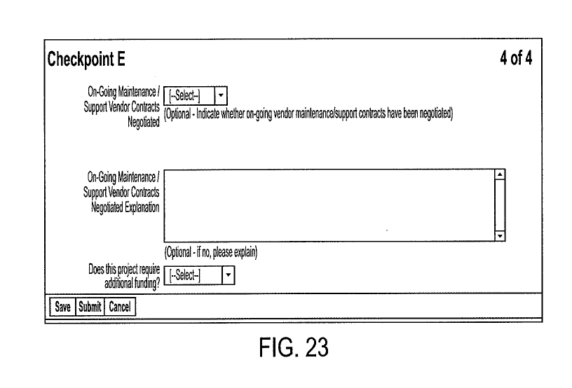

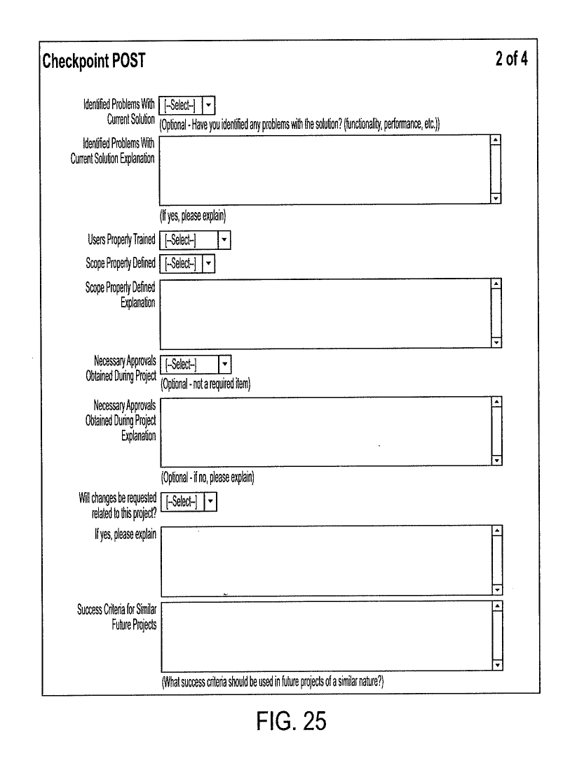

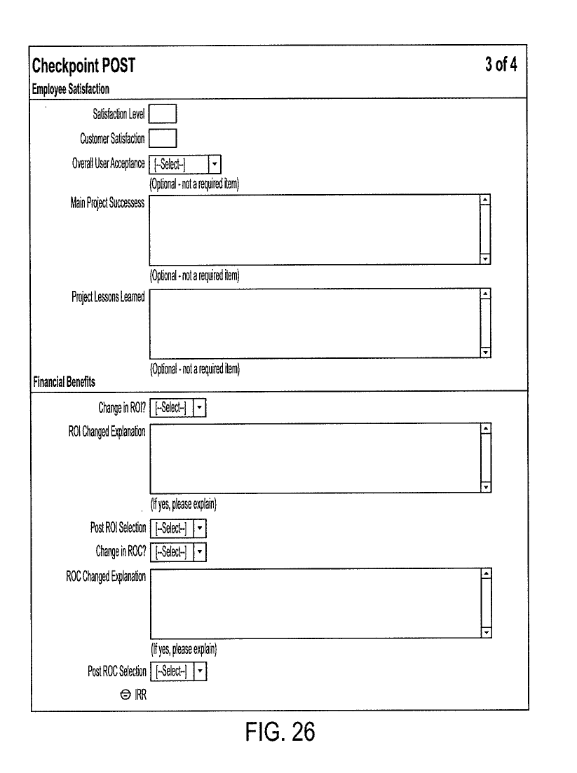

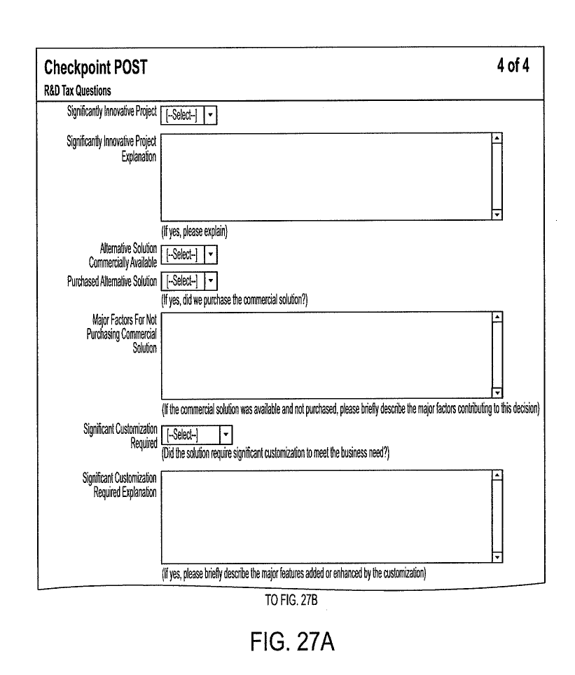

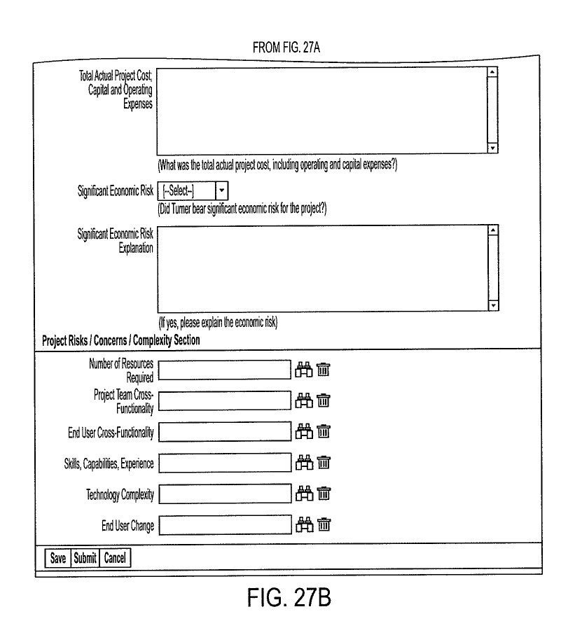

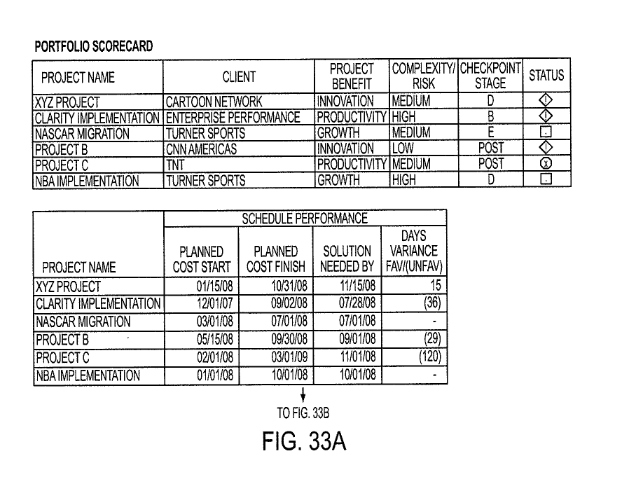

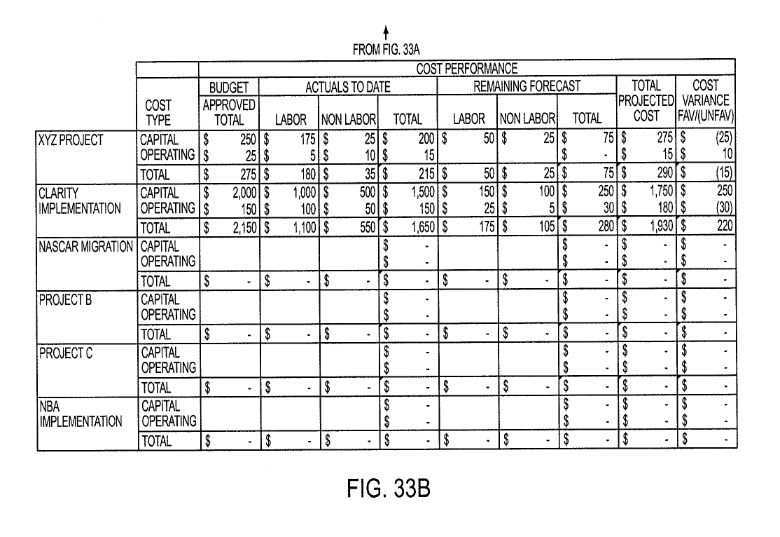

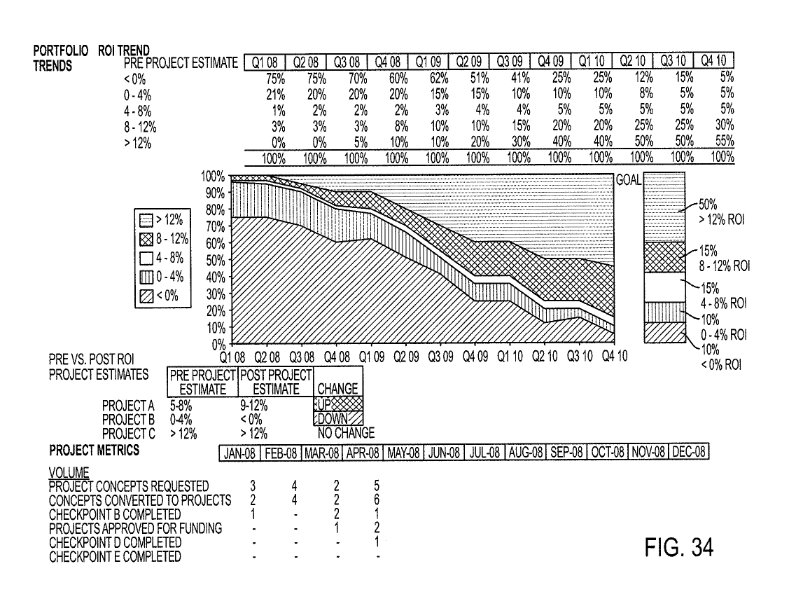

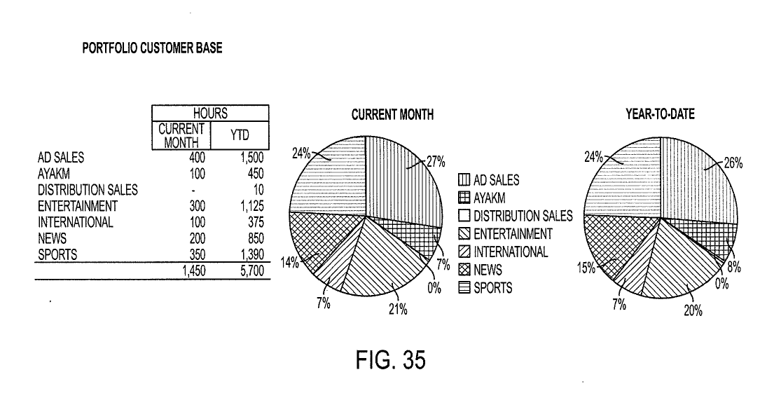

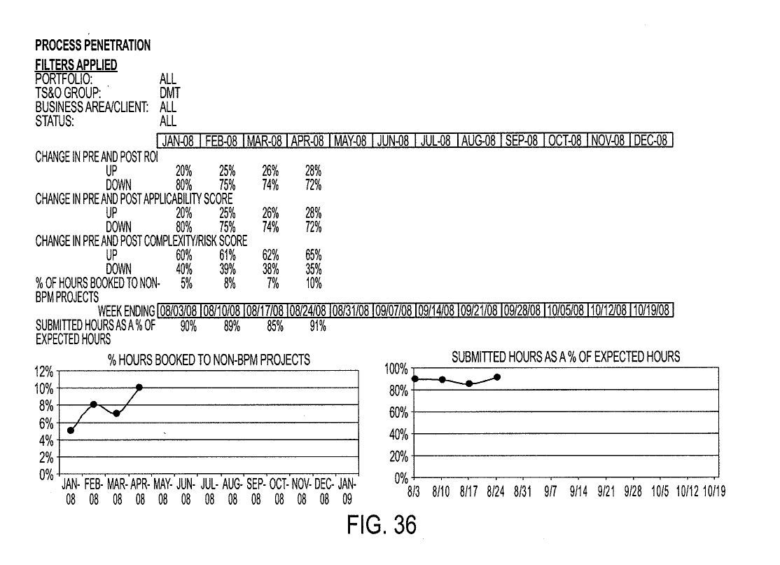

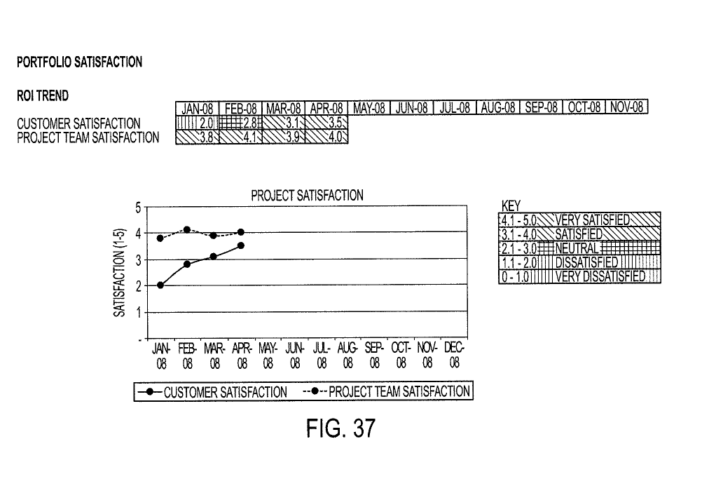

Reference will now be made to FIGS. 3-38. FIGS. 3-4 provide flowcharts illustrating operations that may be performed to prioritize and track investment projects. FIGS. 5-38 show universal input and output produced by one embodiment of the invention.

Generally, various embodiments of the present invention are related to prioritizing and tracking investment projects to ensure that an entity's resources are utilized in a manner the entity desires (e.g., in ways that are consistent with the entity's investment goals). An investment project may involve the use of an entity's personnel resources, capital/financial resources, image or name, research and development resources, or the like. Illustrative investment projects may include campaign launches, IT projects, marketing launches, product development, asset acquisitions, or the like. To prioritize and track investment projects, embodiments of the present invention provide the functionality that enables entities to (a) understand the goals, risks, and rewards of potential investment projects; (b) efficiently evaluate the plans of a variety of investment projects; and (c) track the progress of investment projects from conceptualization to completion.

a. Investment Project Conceptualization

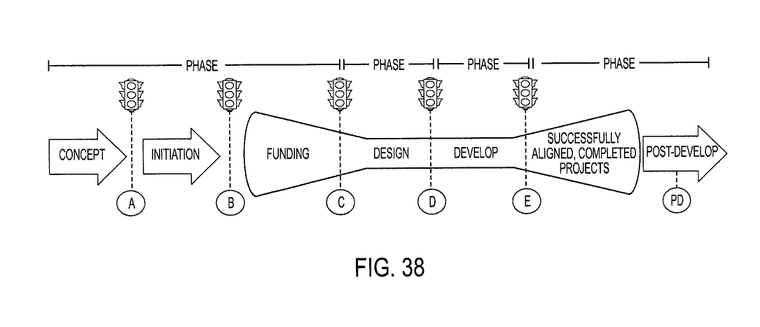

In one embodiment, the computer system (or a computer program product) implements a stage-gate process for evaluating and implementing investment projects (shown in FIG. 38). For example, in one embodiment, after a project has been conceptualized, the process begins with the investment system 100 receiving input identifying an investment project (Block 300) for consideration (e.g., via an interface such as the one shown in FIG. 5). For example, in one embodiment, the input identifying an investment project (and other input) is received from a user of a user computing device 110 entering the name of an investment project (e.g., via a keyboard, mouse, or other input device). The investment system 100 is configured to then associate the investment project with a unique identifier. The unique identifier may be, for example, an identification number (e.g., “00001917”) that can be used by the investment system 100 to reference, retrieve, and/or identify information about the investment project (Block 305). In various embodiments, the unique identifier allows investment projects to be added and removed from portfolios of investment projects, which may allow a user to track all of his or her investment projects through a single interface.

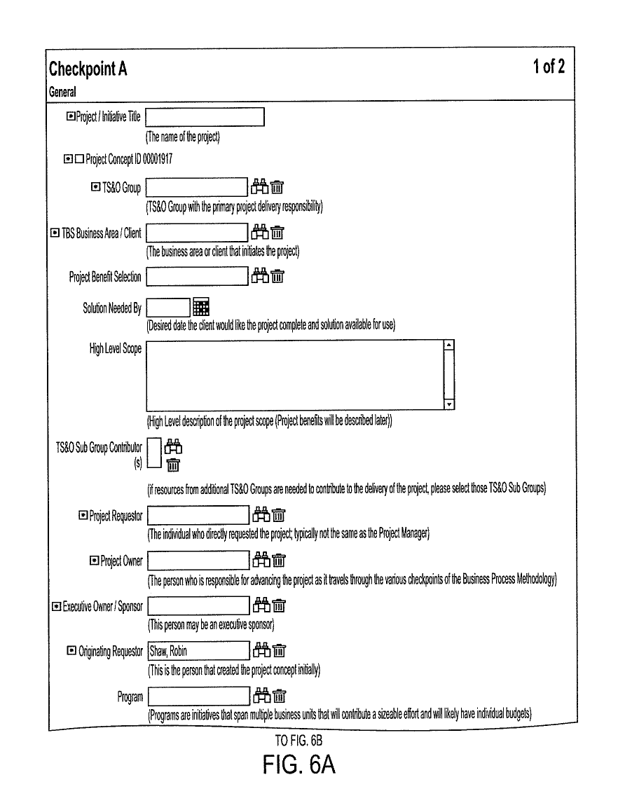

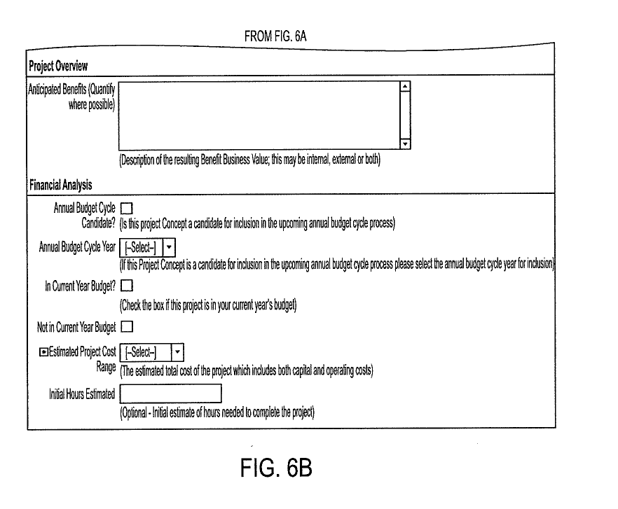

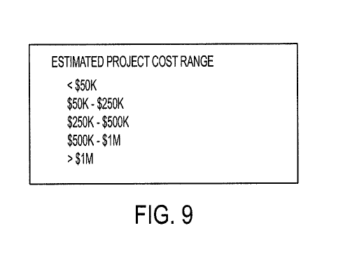

In various embodiments, the investment system 100 is configured to cause display of general questions or other general input requests (e.g., a set of general input requests) related to the investment project (such as via the interface shown in FIG. 5). For example, as shown in FIGS. 6 and 9 (also identified as Checkpoint A), the investment system 100 causes display (e.g., on a user computing device 110 via an interface) of a set of general input requests, such as information requests regarding: (1) the group sponsoring the investment project; (2) the start date of the investment project; (3) the completion date of the investment project; (4) the requestor of the investment project; (5) the owner of the investment project; and (6) the contributors to the investment project. The set of general input requests may also include budgetary information, such as the applicable budget cycles, the applicable budget year(s), the estimated cost of the investment project (e.g., FIG. 9 and Block 315), and the initial number of hours estimated for the investment project.

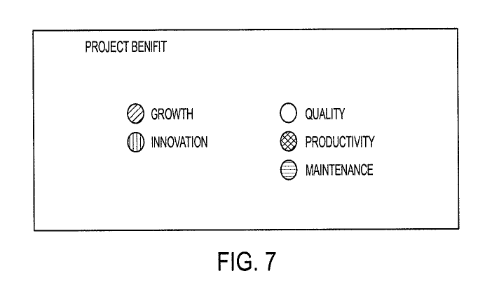

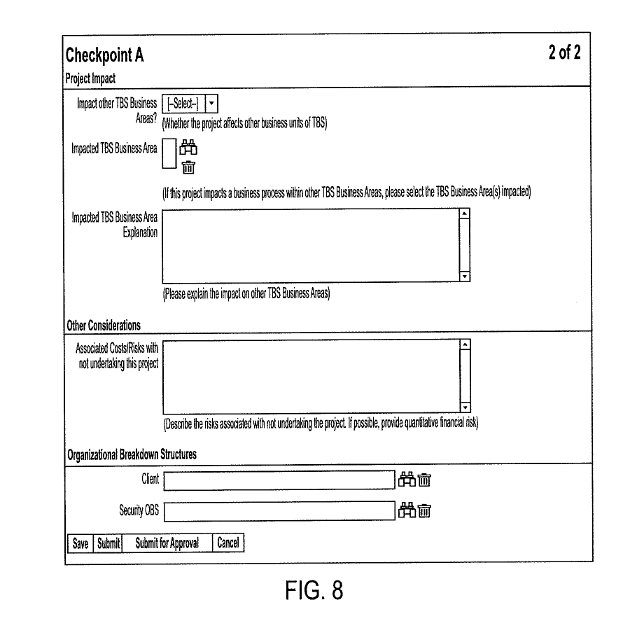

Other general input requests may be related to areas of impact for the entity's business units, such as the impacted organizations of the business, the associated costs of undertaking the investment project (shown in FIG. 8), and the associated risks of undertaking the investment project. And finally, in one embodiment, responses to the general input requests identify one or more expected benefits of the investment project (Block 310). For example, an expected benefit of the investment project may be (a) growing the entity, (b) maintaining the entity's market position, (c) increasing employee productivity, (d) increasing the quality of a product, or (e) providing an innovative product or service (shown in FIG. 7). In various embodiments, identifying the expected benefit of the investment project may be helpful in understanding the overall objectives of the investment project so that the expected benefit can be reviewed for consistency with an entity's goals and strategic needs.

In various embodiments, in response to the general input requests, the investment system 100 receives user input responding to the general input requests (e.g., input from a user of a user computing device 110). The input may be entered via drop down menus, radio buttons, text boxes, voice recognition software, or the like. After the input has been received by the investment system 100, the investment system 100 is configured to verify the entered data for compliance with data input requirements, such as limits on input values, requirements that certain questions be answered, or the like. If the input is not in compliance with the data input requirements, the investment system 100 causes display (e.g., on a user computing device 110 via an interface) of an error message and requires that the input be in compliance with the data input requirements to move forward with the process. Once the necessary input has been received, the investment system 100 receives input (e.g., input from a user of a user computing device 110) requesting submission of the investment project for an initial approval. Generally, this is to determine whether the investment project is something that should be considered further by the entity or terminated. In response, the investment system 100 (a) submits the investment project for initial approval and (b) provides notification to a user computing device 100 that the investment project has been submitted for initial approval.

In response to submission of the investment project for initial approval, the investment system 100 receives an initial approval or denial of the investment project (e.g., from a user computing device 110 of a user with a specific role or certain permissions defined within the investment system 100). As part of the approval process, the investment system 100 may cause display of the information submitted about the investment project, such as via the interface shown in FIG. 5. If the investment system 100 receives a denial of the investment project, the investment project can be terminated or the investment system 100 can cause display (e.g., on a user computing device 110 via an interface) of the general questions or other general input requests for further refinement by a user (Block 325). If, however, the investment system 100 receives (e.g., from a user computing device 110 of a user with a specific role or certain permissions defined within the investment system 100) an initial approval, the process continues (Block 320).

b. Investment Project Design

In one embodiment, after the initial approval has been received, the investment system 100 is configured to identify input requests (e.g., questions or other input requests that require a response) related to the design of the investment project (Block 330). In one embodiment, the input requests related to the design of the investment project may directly correspond to the expected benefit(s) of the investment project. For example, each expected benefit may be associated with a specific input requests (e.g., questions or other input requests that require a response) related to the design of the investment project. Thus, the expected benefit of growing an entity may be associated with input requests that include requests as to how the investment project will grow the entity and the estimated length of time necessary to achieve the growth.

The expected benefit of increasing the quality of a product may be associated with input requests that include requests as to what the expected return on investment (“ROI”) or return on capital (“ROC”) will be for the investment project. Exemplary expected benefits with potential ROI ranges are provided below in Table 1. In one embodiment, the ROI (and ROC) information can be integral parts of the decision making process. For example, the ROI information can be leveraged to help support or determine a tactical timeline and execution of a project.

TABLE 1

| Project Benefit Selection | ROI Range |
|---|---|
| Growth | Should have an ROI greater than 0% |
| Innovation | Could have any ROI range |
| Productivity | Should have an ROI greater than 0% |
| Quality | Could have any ROI range |
| Maintenance | Will likely have a low or negative ROI range |

The expected benefit of maintaining the entity's market position may be associated with input requests or questions that include requests as to whether marketing surveys or other information provide support indicating that the investment project will help in maintaining the entity's market position. The input requests associated with each expected benefit may be customized based on the nature of the benefit. There may also be overlap and duplication to the questions or requested inputs associated with the respective expected benefits. And although, in one embodiment, each expected benefit is associated with input requests related to the design of the investment project, in another embodiment, each expected benefit is associated with the same input requests related to the design of the investment project.

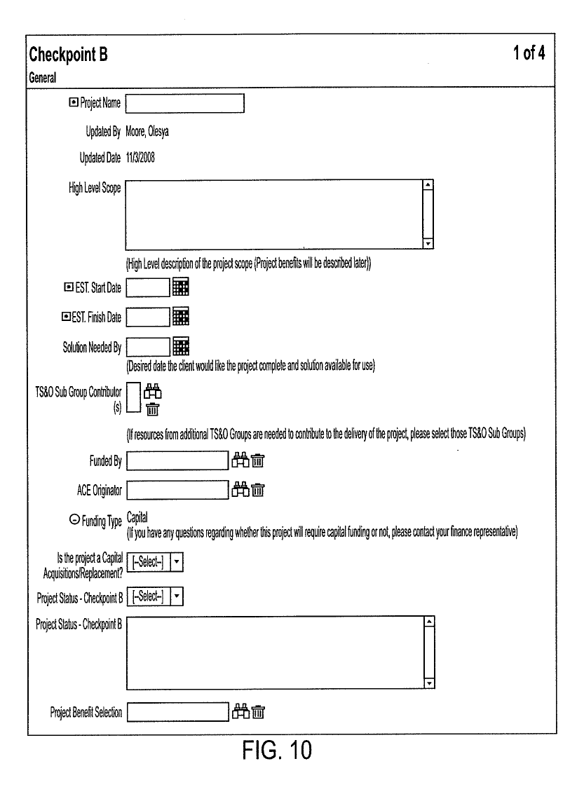

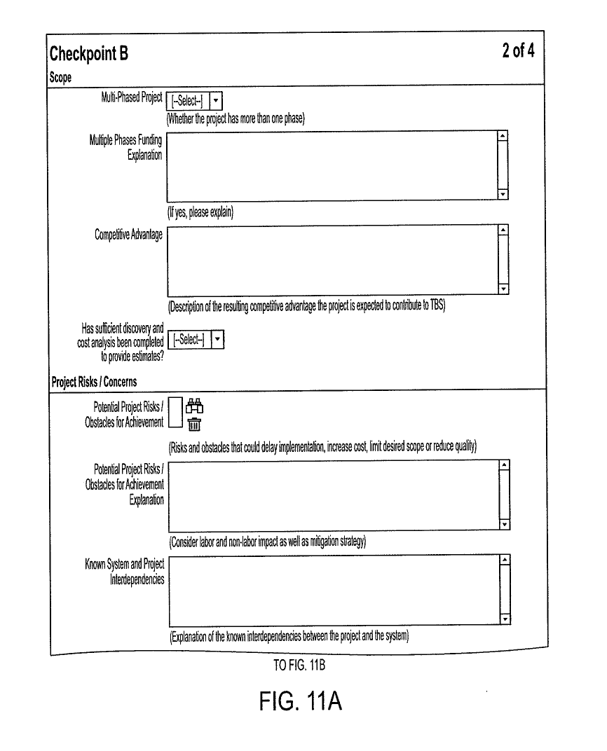

After the input requests related to the design of the investment project has been identified, the investment system 100 is configured to cause display (e.g., on a user computing device 110 via an interface) of the input requests related to the design of the investment project (Block 335). For example, illustrative input requests related to the design of an investment project are shown in FIGS. 10-13 (also identified as Checkpoint B). In these figures, the input requests related to the design of an investment project may include the source of the funding for the investment project, the current status the investment project, and the design and build phases of the investment project.

Similarly, as a way to further evaluate the investment project, the investment system 100 is configured to cause display of input requests regarding certain risks or potential concerns of the investment project. For example, as shown in FIG. 10, the input requests include requests for information about: (1) the number of resources required to implement the investment project; (2) the end user cross-functionality of the investment project; (3) the project team cross-functionality of the investment project; (4) the available skills, capabilities, and experience of potential team members; (5) the technical complexity of the investment project; and/or (5) the end user change as a result of the investment project.

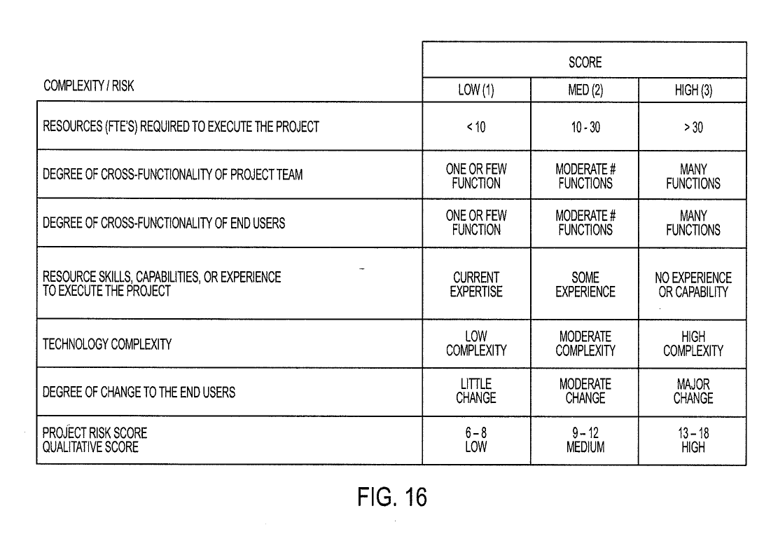

In one embodiment, shown in FIG. 16, the responses to these input requests can be categorized and associated with risk scores. The risk scores may be numbers, letters, or any of a number of factors used to identify the potential risks associated with a response to a specific input request. For example, the number of resources required to implement the investment project may be identified with ranges, such as less than 10 resources (low risk with a risk score of 1), between 10 and 30 resources (medium risk with a risk score of 2), and greater than 30 resources (high risk with a risk score of 3). The available skills, capabilities, and experience of potential team members within an entity may also be a factor in the evaluation of the investment project. Thus, each response may be associated with a risk score as follows—many resources available within the entity with the necessary experience or skills to implement the investment project (low risk with a risk score of 1), some resources available within the entity with the necessary experience or skills to implement the investment project (moderate risk with a risk score of 2), or no resources available within the entity with the necessary experience or skills to implement the investment project (high risk with a risk score of 3). Similarly, the technological complexity of the investment project may be identified. For example, the technological complexity may be low complexity (low risk with a risk score of 1), moderate complexity (moderate risk with a risk score of 2), or high complexity (high risk with a risk score of 3).

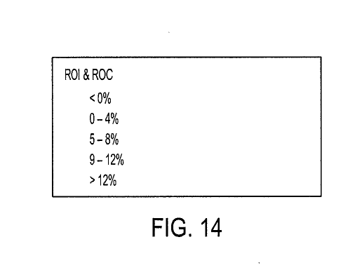

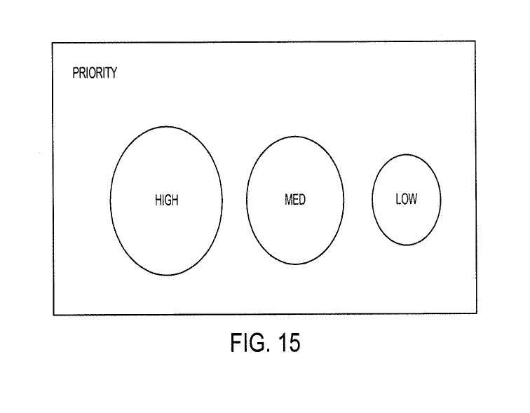

In one embodiment, similar to the specific input requests related to risks and concerns for the investment project, the investment system 100 may also cause display (e.g., on a user computing device 110 via an interface) of input requests related to the priority, ROI, and ROC of the investment project (Blocks 345 and 350). For example, as shown in FIG. 15, the priority of the investment project may be categorized as low, medium, or high (or using other methods). In one embodiment, each priority is associated with a risk score. Further, the ROI and/or ROC of the investment project may be identified using ranges, such as those shown in FIG. 14 and in Table 2 below. And in one embodiment, each range may be associated with a risk score, e.g., 0% ROI or ROC (risk score of 5), 0%-4% ROI or ROC (risk score of 4), 5%-8% ROI or ROC (risk score of 3), 9%-12% ROI or ROC (risk score of 2), >12% ROI or ROC (risk score of 1).

TABLE 2

| ROI Ranges | | Financial Components of the Investment Project |
|---|---|---|
| <0 | % | All costs and no revenue or cost savings |
| 0-4 | % | Significant costs compared to little revenue or cost |
| | | savings |
| 4-8 | % | Somewhat significant costs compared to little revenue |
| | | or cost savings |
| 8-12 | % | Somewhat significant costs compared to decent revenue |
| | | or cost savings |
| >12 | % | Revenue and cost savings are adequately higher than |
| | | the costs |

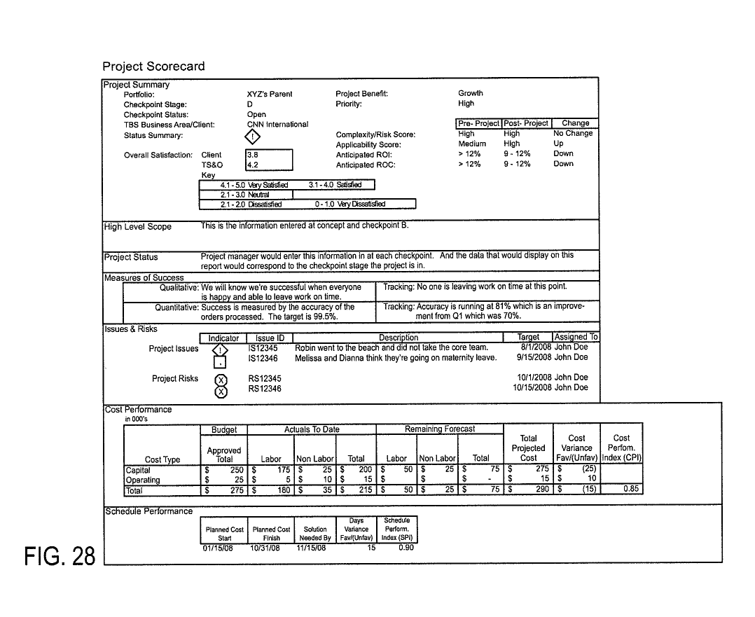

In one embodiment, in response to causing display of the input requests related to the design of the investment project, the investment system 100 receives user input (e.g., input from a user of a user computing device 110) responding to the input requests as, for example, described above. At this point, the investment system 100 can aggregate the risk scores into, for example, an overall risk score or multiple categorized risk scores (Block 400 and FIG. 28). As will be recognized, not all of the responses to the input requests are associated with risk scores. For example, the priority, ROI, and ROC of the investment project are not associated with risk scores in certain embodiments.

Once the necessary input has been received (e.g., Blocks 340, 345, 350), the investment system 100 receives input (e.g., input from a user of a user computing device 110) requesting submission of the investment project for design approval. In response, the investment system 100 (a) submits the investment project for design approval and (b) provides notification to a user computing device 100 that the investment project has been submitted for design approval. Generally, this is to determine whether the investment project is something that should actually be developed or terminated. In response to submission of the investment project for design approval, the investment system 100 receives a design approval or denial of the investment project (e.g., from a user computing device 110 of a user with a specific role or certain permissions defined within the investment system 100). As part of the approval process, the investment system 100 is configured to cause display of the information submitted about the investment project, such as via an investment project scorecard shown in FIG. 28. If the investment system 100 receives a denial of the investment project, the investment project can be terminated or the investment system 100 can cause display (e.g., on a user computing device 110 via an interface) of the input requests related to the design of the investment project for further refinement by a user (Block 410). If, however, the investment system 100 receives (e.g., from a user computing device 110 of a user with a specific role or certain permissions defined within the investment system 100) a design approval, the process continues with the design of the investment project being approved (Block 405).

c. Investment Project Development

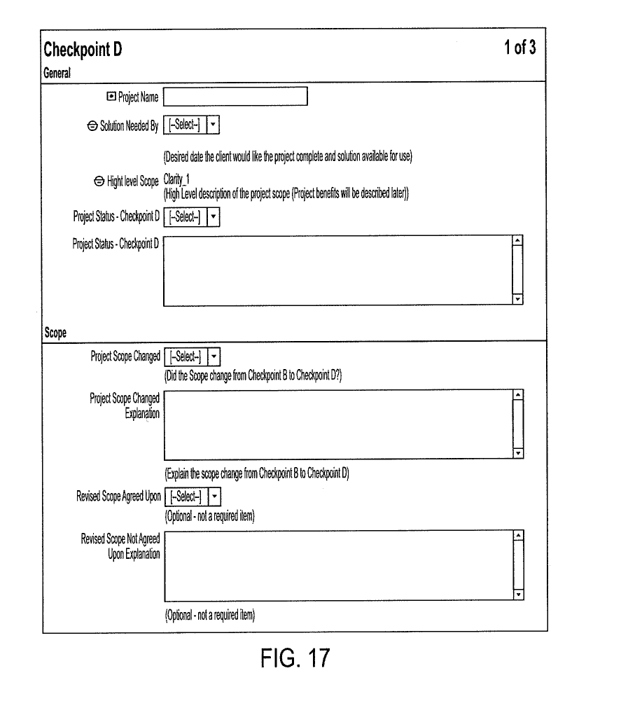

In one embodiment, after the design of the investment project has been approved, development of the investment project may begin. To ensure that the investment project is developed within the proposed guidelines and specifications that have been approved, the investment system 100 is configured to allow review of the development of the investment project during the actual development process. In various embodiments, this functionality may allow the entity to stay within certain predefined tolerance and risk levels. For example, as shown in FIGS. 17-19 (also identified as Checkpoint D), the investment system 100 may cause display (e.g., on a user computing device 110 via an interface) of input requests related to the development of the investment project (Block 415). In one embodiment, the input requests related to the development of the investment project may include requests for information such as requesting information about (a) changes to the scope of the investment project, (b) changes to the cost of the investment project, (c) changes to the completion date of the investment project (and reasons for any delays), (d) the overall status of the investment project, (e) the overall status of the investment project, (f) specific qualitative and quantitative measures of success for the investment project, (g) issue and risk tracking for the investment project, and/or (h) schedule performance. It should be recognized that the input requests related to the development of the investment project can be customized to provide any feedback necessary (at any stage of the process) to determine whether development of the investment project should continue or be terminated.

Once the necessary input has been received (Block 420), the investment system 100 receives input (e.g., input from a user of a user computing device 110) requesting submission of the investment project for continued development approval. In response, the investment system 100 (a) submits the investment project for continued development approval and (b) provides notification to a user computing device 100 that the investment project has been submitted for continued development approval. As part of the approval process, the investment system 100 may cause display of the information submitted about the investment project. In response to submission of the investment project for continued development approval, the investment system 100 receives a continued development approval or denial of the investment project (e.g., from a user computing device 110 of a user with a specific role or certain permissions defined within the investment system 100). If the investment system 100 receives a denial of the investment project, the investment project can be terminated or the investment system 100 can cause display (e.g., on a user computing device 110 via an interface) of the input requests related to the development of the investment project for further refinement by a user (Block 430). If, however, the investment system 100 receives (e.g., from a user computing device 110 of a user with a specific role or certain permissions defined within the investment system 100) a continued development approval, the process continues with the continued development of the investment project being approved (Block 425). As will be recognized, one or more stages of continued development approval may be used throughout the development of the investment project.

d. Investment Project Completion and Feedback

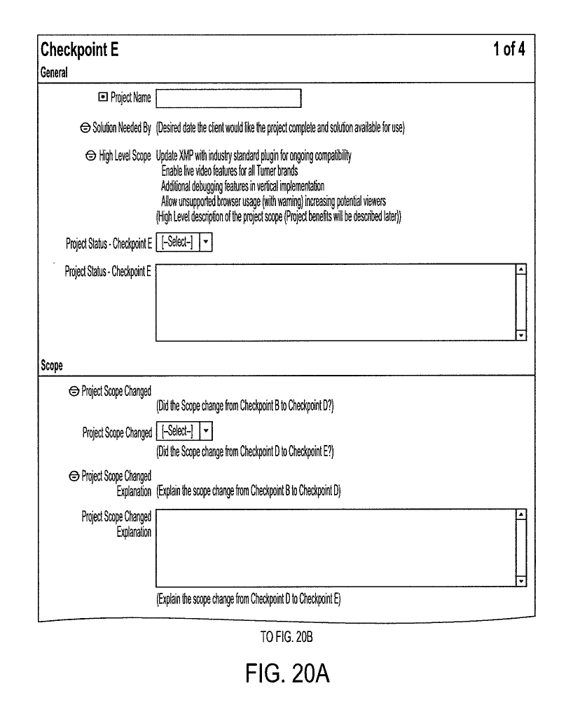

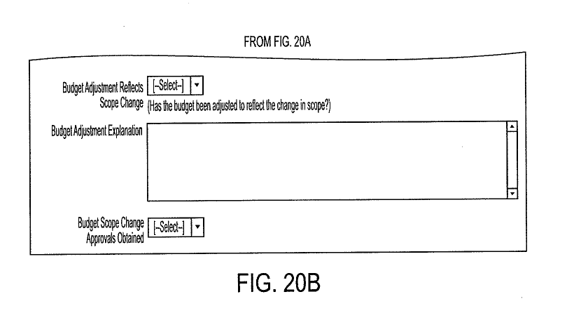

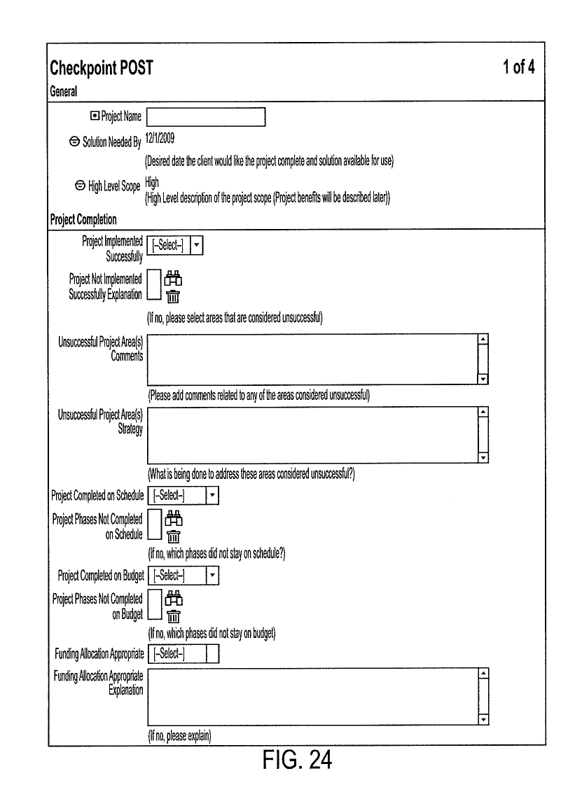

In one embodiment, after the investment project has been completed, the investment system 100 receives input (e.g., input from a user of a user computing device 110) indicating that the investment project is complete (Block 435). In response to this input, the investment system 100 can cause display (e.g., on a user computing device 110 via an interface) of input requests related to the completion of the investment project (Block 440). For example, as shown in FIGS. 20-27 (and identified as Checkpoint E and Checkpoint Post), the input requests about the completion of the investment project may include requests for information about (a) compliance with the design requirements, (b) compliance with the cost requirements, (c) compliance with the time requirements, (d) whether any portions of the investment project are incomplete, (e) planned training about the investment project, (f) personnel hours used for development of the investment project, and (g) any necessary maintenance for the investment project. The input requests about the completion of the investment project may also include requests for input about (a) the realized ROI, (b) the realized ROC, (c) the accuracy of risk scores, (d) the satisfaction of the project team, (e) consumer satisfaction surveys, and (f) the accuracy of any pre-development surveys. It should be recognized that the input requests related to the completion of the investment project can be customized to provide any feedback desired. Also, the input may be broken into multiple stages, such as those shown as Checkpoint E and Checkpoint Post in FIGS. 20-27. For example, in one embodiment, the input requests shown in FIGS. 24-27 may not be answerable until some time after the investment project has been completed.

Once the necessary input has been received (Block 445), the investment system 100 may provide the information for review to one or more users (e.g., via user computing devices 110) with certain permissions within the investment system 100. In various embodiments, this information may be useful in reviewing the plan, development, and completion of the investment project.

e. Portfolio Management

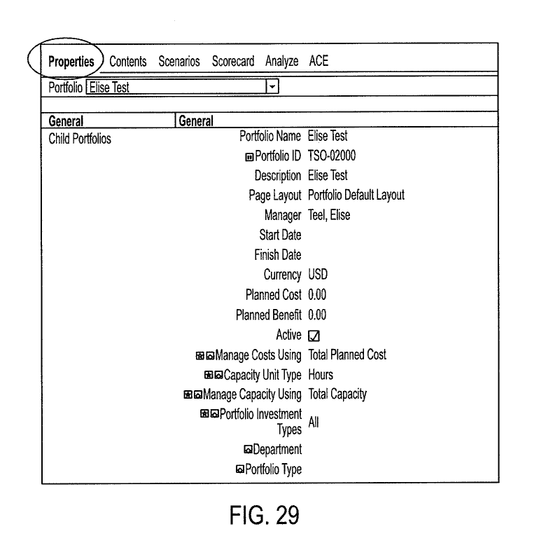

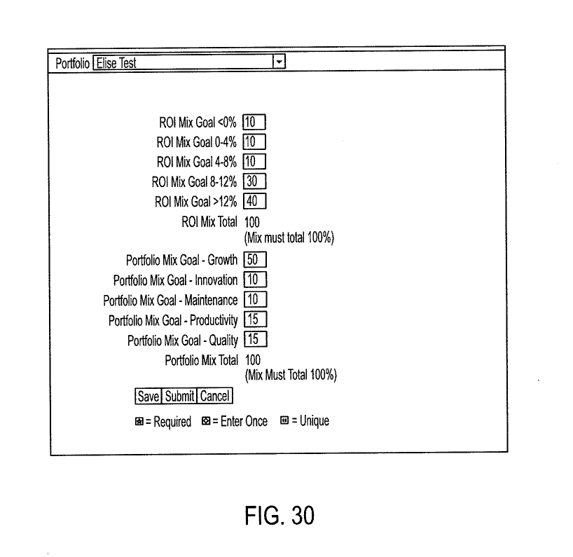

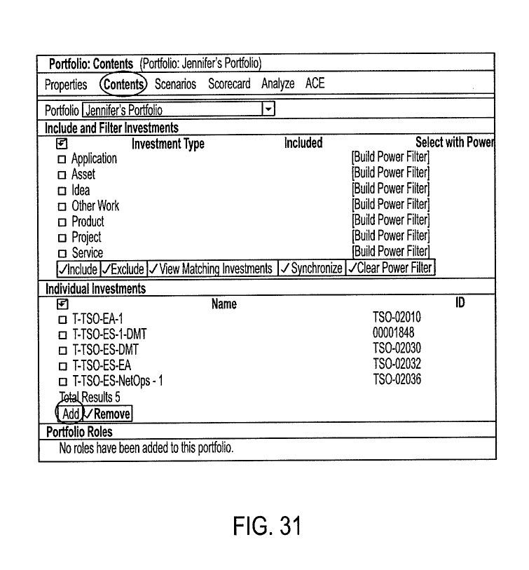

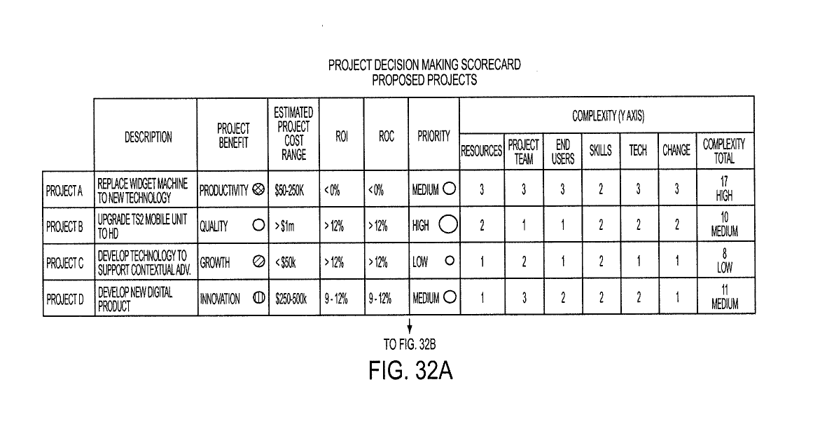

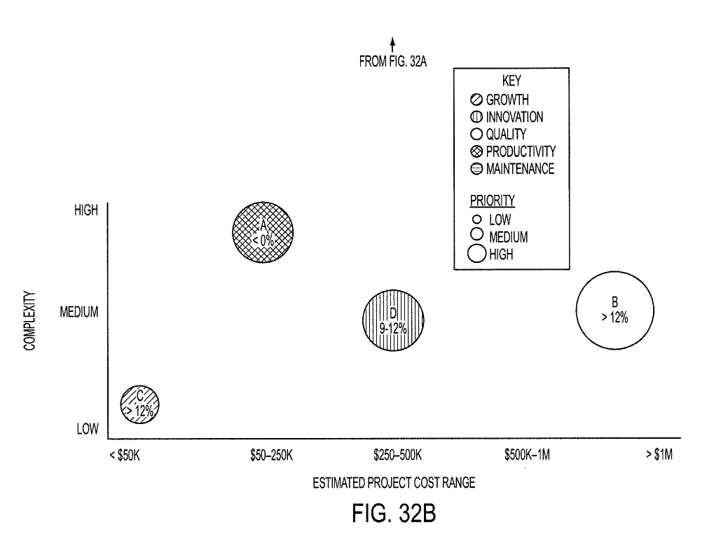

In one embodiment, in addition to providing the described functionality, the investment system 100 can also provide for the management of multiple investment projects within one or more investment portfolios. For example, investment portfolios can be designed to comply with certain investment objectives, such as having a portfolio with a specific aggregated ROI or a diverse range of expected benefits (shown in FIGS. 29 and 30). In that regard, investment projects can be added to and removed from an investment portfolio (shown in FIG. 31). In one embodiment, as the investment projects are added to an investment portfolio, each investment project can be reviewed by the investment system 100 to determine if the addition of the investment project to the investment portfolio would be in compliance with objectives defined for the investment portfolio. Moreover, the investment system 100 can provide is adapted to provide portfolio reports (such as those shown in FIGS. 32-37) to assist a user in tracking and making decisions with regard to a portfolio.

### V. CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for prioritizing and tracking one or more investment projects, the computer-implemented method comprising:
receiving input identifying an investment project;
assigning a unique identifier to the investment project;
receiving input identifying an estimated cost for the investment project;
receiving input identifying an expected benefit of the investment project;
causing display of a first input request that is related to the design of the investment project and that is associated with the expected benefit;
receiving a response to the first input request;
causing display of a second input request that is related to the development of the investment project;
receiving a response to the second input request;
receiving input indicating that the investment project has been completed; and
in response to receiving input indicating that the investment project has been completed, causing display of a third input request that is related to feedback of the investment project.

2. A computer-implemented method for prioritizing and tracking one or more investment projects, the computer-implemented method comprising:
receiving, via one or more processors, input identifying an investment project;
receiving, via the one or more processors, input identifying an expected benefit of the investment project;
receiving, via the one or more processors, input requesting submission of the investment project for initial approval;
in response to receiving input requesting submission of the investment project for initial approval, electronically (a) submitting the investment project for initial approval and (b) providing notification to a user computing device that the investment project has been submitted for initial approval; and
causing display of a first input request that is related to the design of the investment project and that is associated with the expected benefit.

3. The computer-implemented method of claim 2 further comprising:
assigning, via the one or more processors, a unique identifier to the investment project; and
receiving, via the one or more processors, input identifying an estimated cost for the investment project.

4. The computer-implemented method of claim 2 further comprising:
in response to submitting the investment project for initial approval, receiving an initial approval or a denial of the investment project; and
in response to receiving an initial approval of the investment project, identifying the first input request that is related to the design of the investment project and that is associated with the expected benefit.

5. The computer-implemented method of claim 4 further comprising receiving a response to the first input request, wherein receiving a response to the first input request comprises:
receiving, via the one or more processors, input identifying a priority for the investment project; and
receiving input identifying expected risk levels for each of a plurality of expected risks of the investment project, wherein (a) the expected risk levels are selected from the group consisting of (i) high risk, (ii) medium risk, and (ii) low risk; (b) the expected risks are selected from the group consisting of (i) resources required for the investment project and (ii) technology complexity; and (c) and each risk level and corresponding expected risk are associated with a risk score.

6. The computer-implemented method of claim 5, wherein receiving a response to the second input request further comprises:
receiving, via the one or more processors, input identifying an estimated return on investment (ROI) for the investment project, wherein the estimated ROI is selected from a plurality of ranges; and
receiving, via the one or more processors, input identifying an estimated return on capital (ROC) for the investment project, wherein the estimated ROC is selected from a plurality of ranges with each range being associated with a risk score.

7. The computer-implemented method of claim 6 further comprising:
receiving input requesting submission of the investment project for design approval;
in response to receiving input requesting submission of the investment project for design approval, electronically (a) submitting the investment project for design approval and (b) providing notification to a user computing device that the investment project has been submitted for design approval;
in response to submitting the investment project for design approval, receiving a design approval or a denial of the investment project;
in response to receiving a design approval of the investment project, electronically (a) providing notification to a user computing device that the investment project has received a design approval and (b) causing display of a second input request that is related to the development of the investment project; and
receiving a response to the second input request.

8. The computer-implemented method of claim 7 further comprising:
receiving input requesting submission of the investment project for continued development approval; and
in response to receiving input requesting submission of the investment project for continued development approval, electronically (a) submitting the investment project for continued development approval and (b) providing notification to a user computing device that the investment project has been submitted for continued development approval.

9. The computer-implemented method of claim 2 further comprising:
receiving input indicating that the investment project has been completed;
in response to receiving input indicating that the investment project has been completed, causing display of a third input request that is related to feedback of the investment project; and
receiving a response to the third input request.

10. A computer program product for prioritizing and tracking one or more investment projects, the computer program product comprising at least one computer-readable storage medium having computer-readable program code portions stored therein, the computer-readable program code portions comprising:
an executable portion configured to receive input identifying an investment project;
an executable portion configured to receive input identifying an expected benefit of the investment project;
an executable portion configured to receive input requesting submission of the investment project for initial approval;
an executable portion configured to, in response to receiving input requesting submission of the investment project for initial approval, (a) submit the investment project for initial approval and (b) provide notification to a user computing device that the investment project has been submitted for initial approval; and
an executable portion configured to cause display of a first input request that is related to the design of the investment project and that is associated with the expected benefit.

11. The computer program product of claim 10 further comprising:
an executable portion configured to assign a unique identifier to the investment project; and
an executable portion configured to receive input identifying an estimated cost for the investment project.

12. The computer program product of claim 10 further comprising:
an executable portion configured to, in response to submitting the investment project for initial approval, receive an initial approval or a denial of the investment project; and
an executable portion configured to, in response to receiving an initial approval of the investment project, identify the first input request that is related to the design of the investment project and that is associated with the expected benefit.

13. The computer program product of claim 12 further comprising an executable portion configured to receive a response to the first input request, wherein receiving a response to the first input request comprises:
an executable portion configured to receive input identifying a priority for the investment project; and
an executable portion configured to receive input identifying expected risk levels for each of a plurality of expected risks of the investment project, wherein (a) the expected risk levels are selected from the group consisting of (i) high risk, (ii) medium risk, and (ii) low risk; (b) the expected risks are selected from the group consisting of (i) resources required for the investment project and (ii) technology complexity; and (c) and each risk level and corresponding expected risk are associated with a risk score;
an executable portion configured to receive input identifying an estimated return on investment (ROI) for the investment project, wherein the estimated ROI is selected from a plurality of ranges; and
an executable portion configured to receive input identifying an estimated return on capital (ROC) for the investment project, wherein the estimated ROC is selected from a plurality of ranges with each range being associated with a risk score.

14. The computer program product of claim 13 further comprising:
an executable portion configured to receive input requesting submission of the investment project for design approval;
an executable portion configured to, in response to receiving input requesting submission of the investment project for design approval, (a) submit the investment project for design approval and (b) provide notification to a user computing device that the investment project has been submitted for design approval;
an executable portion configured to, in response to submitting the investment project for design approval, receive a design approval or a denial of the investment project;
an executable portion configured to, in response to receiving a design approval of the investment project, (a) provide notification to a user computing device that the investment project has received a design approval and (b) cause display of a second input request that is related to the development of the investment project; and
an executable portion configured to receive a response to the second input request.

15. The computer program product of claim 14 further comprising:
an executable portion configured to receive input requesting submission of the investment project for continued development approval; and
an executable portion configured to, in response to receiving input requesting submission of the investment project for continued development approval, (a) submit the investment project for continued development approval and (b) provide notification to a user computing device that the investment project has been submitted for continued development approval.

16. The computer program product method of claim 10 further comprising:
an executable portion configured to receive input indicating that the investment project has been completed;
an executable portion configured to, in response to receiving input indicating that the investment project has been completed, cause display of a third input request that is related to feedback of the investment project; and
an executable portion configured to receive a response to the third input request.

17. A system for prioritizing and tracking one or more investment projects, the system comprising one or more memory storage areas and one or more processors, the system configured to:
receive input identifying an investment project;
receive input identifying an expected benefit of the investment project;
receive input requesting submission of the investment project for initial approval;
in response to receiving input requesting submission of the investment project for initial approval, (a) submit the investment project for initial approval and (b) provide notification to a user computing device that the investment project has been submitted for initial approval;
cause display of a first input request that is related to the design of the investment project and that is associated with the expected benefit; and
receive a response to the first input request.

18. The system of claim 17 further configured to:
assign a unique identifier to the investment project; and
receive input identifying an estimated cost for the investment project.

19. The system of claim 10 further configured to:
in response to submitting the investment project for initial approval, receive an initial approval or a denial of the investment project; and
in response to receiving an initial approval of the investment project, identify the first input request that is related to the design of the investment project and that is associated with the expected benefit.

20. The system of claim 19 further configured to:
receive input requesting submission of the investment project for design approval;
in response to receiving input requesting submission of the investment project for design approval, (a) submit the investment project for design approval and (b) provide notification to a user computing device that the investment project has been submitted for design approval;
in response to submitting the investment project for design approval, receive a design approval or a denial of the investment project;
in response to receiving a design approval of the investment project, (a) provide notification to a user computing device that the investment project has received a design approval and (b) cause display of a second input request that is related to the development of the investment project; and
receive a response to the second input request.

21. The system of claim 14 further configured to:
receive input requesting submission of the investment project for continued development approval; and
in response to receiving input requesting submission of the investment project for continued development approval, (a) submit the investment project for continued development approval and (b) provide notification to a user computing device that the investment project has been submitted for continued development approval.

22. The system of claim 21 further configured to:
receive input indicating that the investment project has been completed;
in response to receiving input indicating that the investment project has been completed, cause display of a third input request that is related to feedback of the investment project; and
receive a response to the third input request.
